(19) United States
(12) Patent Application Publication
(10) Pub. No.: US 2004/0262058 A1
(43) Pub. Date: Dec. 30, 2004

(54) Vehicle electrical system with fuel cell and process for operating an electrical consumer in such a vehicle electrical system

(75) Inventors: Matthias Boltze, Neuendorf (DE); Christian Wunderlich, Chemnitz (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/828,496

(22) Filed: Apr. 21, 2004

(30) Foreign Application Priority Data
Apr. 22, 2003 (DE) 103 18 172.5

(51) Int. Cl. B60K 1/00

(52) U.S. Cl. 180/65.3; 180/65.1

(57) ABSTRACT

A vehicle electrical system, especially for a motor vehicle, with an APU (auxiliary power unit) based on a fuel cell and a DC/DC converter for converting the DC voltage which is generated by the fuel cell (10) in order to match it to the voltage of the vehicle electrical system, and a process for operating an electrical consumer (14) with electrical power, with which some of the electrical power delivered from the fuel cell (10) is supplied to at least one electrical consumer (14) without conversion by the DC/DC converter (12).

### BACKGROUND OF THE INVENTION

1. Field of the Invention

The invention relates to a vehicle electrical system, especially for a motor vehicle, with an APU (auxiliary power unit) based on a fuel cell and a DC/DC converter for converting the DC voltage which is generated by the fuel cell in order to match it to the voltage of the vehicle electrical system.

2. Description of Related Art

The invention furthermore relates to a process for operating an electrical consumer with electrical power which is delivered by a fuel cell-based APU (auxiliary power unit), a DC/DC converter being provided for conversion of the DC voltage generated in the fuel cell in order to adapt this DC voltage to the voltage of the vehicle electrical system.

In modern motor vehicles, there is increasingly an elevated demand for electrical power, for example, for making available luxury functions, for example, auxiliary climate control. For this reason, it is provided that the vehicle electrical systems be equipped with auxiliary units for supplying electrical power. In this connection, fuel cell-based APUs (auxiliary power units) are especially promising since they can produce and deliver electrical power independently of the internal combustion engine.

Since the voltage range of these fuel cells varies depending on the load between roughly 60% and 100% of the maximum voltage of the vehicle electrical system, it is necessary to adapt the delivered voltage to the voltage of the vehicle electrical system via a DC/DC converter. Examples of these vehicle electrical systems with a fuel cell and a DC/DC converter which is intended for voltage conditioning are given, for example, in German Patent DE 198 10 556 C1, published German Patent Application DE 101 05 087 A1 which corresponds to U.S. Pat. No. 6,323,626, and published German Patent Application DE 198 10 468 A1 which corresponds to U.S. Pat. No. 6,577,026.

However, the increased electrical power demand in modern motor vehicles entails problems with respect to the indicated technology. For example, at an APU electrical wattage of around 5 kW, it is necessary to use a very complex and thus costly DC/DC converter in order to stabilize the fuel cell voltage to the voltage of the vehicle electrical system. In addition, these converters are currently not yet available and must be developed first; this is fundamentally possible, but would be in turn associated with a very high complexity and cost.

### SUMMARY OF THE INVENTION

A primary object of the present invention is to eliminate the problems of the prior art and especially to provide a vehicle electrical system and a process for operating an electrical consumer without having to rely on development of a DC/DC converter which is suitable for this purpose at a high APU electrical wattage.

This object is achieved for a generic vehicle electrical system by some of the electrical power delivered from the fuel cell being supplied to at least one electrical consumer without conversion by the DC/DC converter. The power matched to the voltage of the vehicle electrical system in the DC/DC converter is limited to an economically efficient amount by supplying a voltage without DC/DC conversion to those consumers which can operate with an unstabilized voltage.

The invention is developed in an especially useful manner in that the fuel cell is connected to one input of the DC/DC converter so that all the useful electrical power delivered by the fuel cell is supplied to this input and that some of the electrical power delivered from the fuel cell can be taken from the unconditioned output of the DC/DC converter without conversion by the DC/DC converter. In this way, it is possible to connect the fuel cell only to the DC/DC converter. Thus, no additional circuitry measures are necessary in the area of the fuel cell. The division of the voltage into a stabilized voltage on the one hand and an unstabilized or unconditioned voltage on the other occurs in the area of the DC/DC converter by transferring the unstabilized part only through the DC/DC converter and making it available at the unconditioned output of the DC/DC converter.

The invention is especially advantageous when the at least one consumer is a high wattage consumer. By not operating the high wattage consumer with stabilized voltage, the DC/DC converter can be designed for a wattage which is reduced by the corresponding amount.

In this connection, it is especially advantageous that the at least one consumer include the compressor motor of an electrically driven air conditioning compressor of a motor vehicle climate control system. Based on the direct coupling of the compressor motor which is operated with DC voltage to the fuel cell voltage, depending on the total load on the fuel cell, the voltage level for supplying the air conditioner compressor motor is different. This results in the rpm of the motor changing; but, this can be accepted since control of the compressor output can be effected independently of the rpm via mechanical matching of the compression stroke by means of a PWM signal.

The vehicle electrical system of the invention can be designed, for example, such that the electrical wattage of the APU is roughly 5 kW.

The advantages and particular features of the vehicle electrical system in accordance with the invention are also implemented within the framework of the process. It is developed in an especially useful manner in that the fuel cell is connected to one input of the DC/DC converter so that all the useful electrical power delivered from the fuel cell is supplied to this input and that some of the electrical power supplied from the fuel cell is taken from the unconditioned output of the DC/DC converter without conversion by the DC/DC converter.

Furthermore in the process of the invention, it is provided that the at least one consumer include a high wattage consumer.

The process in accordance with the invention is developed in an especially advantageous manner in that at least one consumer is the compressor motor of an electrically driven air conditioning compressor of a motor vehicle climate control system.

In this connection, it is especially advantageous that the wattage of the air conditioning compressor is controlled independently of the rpm of the compressor motor via the mechanical triggering of the compression stroke.

Furthermore the process can be used to benefit when the electrical wattage of the APU is roughly 5 kW.

The invention is based on the finding that the size of a DC/DC converter can be limited to an economically efficient amount by especially high wattage electrical consumers, such as for example, electrical air conditioning compressors, being directly supplied with the variable unconditioned fuel cell voltage.

The invention is explained in further detail below with reference to the accompanying drawings using especially preferred embodiments by way of example.

### BRIEF DESCRIPTION OF THE DRAWINGS

FIG. 1 is a schematic illustration of part of a vehicle electrical system in accordance with the invention; and

FIG. 2 is a schematic illustration of part of a vehicle electrical system in accordance with the invention with an electrical consumer.

### DETAILED DESCRIPTION OF THE INVENTION

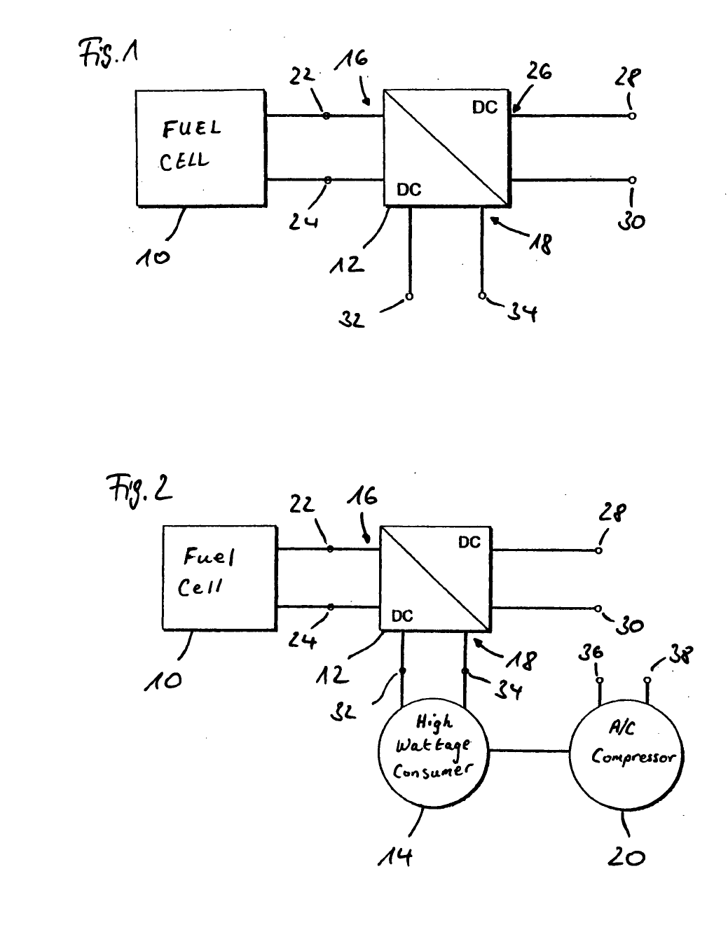

FIG. 1 shows a part of a vehicle electrical system in accordance with a preferred embodiment of the invention in which APU is a fuel cell 10 that has output terminals 22, 24 which are connected to the input 16 of the DC/DC converter 12. The electrical wattage of the fuel cell can advantageously be roughly 5 kW. The DC/DC converter 12 has a stabilized output 26 via which it can make available a stabilized output voltage by means of output terminals 28, 30.

In addition, the DC/DC converter 12 has an unstabilized or unconditioned output 18 via which an unconditioned voltage can be made available by means of output terminals 32, 34. The voltage which is made available at the stabilized output 26 is supplied preferably to the vehicle electrical system for purposes of increasing the wattage.

FIG. 2 shows a schematic of part of the vehicle electrical system of the invention with an electrical consumer 14 which is connected to the output terminals 32, 34 of the unconditioned output 18. The consumer 14, in this example, is a high wattage consumer and especially a compressor motor of an air conditioning compressor 20. This compressor motor 14 can be operated with a voltage level which changes depending on the total load on the fuel cell 10 even if, in this way, the rpm of the motor 14 varies. The compressor wattage can be controlled independently of the rpm via mechanical matching of the compression stroke by feeding a PWM signal via the terminals 36, 38 of the air conditioning compressor 20.

The features of the invention described above, and shown in the drawings can be implemented in accordance with the invention both individually and also in any combination.

What is claimed is:

1. Vehicle electrical system, comprising:
a fuel cell auxiliary power unit and
a DC/DC converter for matching the DC voltage generated by the fuel cell to the voltage of the vehicle electrical system, the DC/DC having an input connected to an output of the fuel cell, a first output for delivering converted electrical power and a second output for delivering unconverted electrical power,
wherein at least one electrical consumer is connected to said second output so that some of the electrical power delivered from the fuel cell is supplied to the at least one electrical consumer without conversion by the DC/DC converter.

2. Vehicle electrical system as claimed in claim 1, wherein the at least one consumer is a high wattage consumer.

3. Vehicle electrical system as claimed in claim 2, wherein the at least one consumer is a compressor motor of an electrically driven air conditioning compressor of a motor vehicle climate control system.

4. Vehicle electrical system as claimed in claim 4, wherein the compressor has a mechanical compression stroke triggering device for controlling the wattage of the air conditioning compressor independently of the rpm of the compressor motor.

5. Vehicle electrical system as claimed in claim 1, wherein the fuel cell auxiliary power unit has an electrical wattage of about 5 kW.

6. Process for operating an electrical consumer with electrical power, comprising the steps of:
delivering a DC voltage generated by a fuel cell auxiliary power unit to a DC/DC converter,
converting a portion of the DC voltage generated by the fuel cell auxiliary power unit to a voltage that is matched to the voltage of the vehicle electrical system,
providing some of the electrical power delivered from the fuel cell auxiliary power unit to at least one electrical consumer without conversion by the DC/DC converter.

7. Process as claimed in claim 6, wherein
the fuel cell is connected to an input of the DC/DC converter so that all the useful electrical power delivered from the fuel cell is supplied to the input of the DC/DC converter, and
some of the electrical power delivered from the fuel cell (10) is taken from an unconditioned output of the DC/DC converter without conversion by the DC/DC converter.

8. Process as claimed in claim 6, wherein the at least one consumer is a high wattage consumer.

9. Process as claimed in claim 8, wherein at least one consumer is the compressor motor of an electrically driven air conditioning compressor of a motor vehicle climate control system.

10. Process as claimed in claim 9, wherein the wattage of the air conditioning compressor is controlled independently of the rpm of the compressor motor via the mechanical triggering of the compression stroke.

11. Process as claimed in claim 6, wherein the electrical wattage of the fuel cell auxiliary power unit is about 5 kW.
